(19) United States
(12) Patent Application Publication
(10) Pub. No.: US 2017/0091875 A1
(43) Pub. Date: Mar. 30, 2017

(54) INFORMATION PROCESSING APPARATUS

(71) Applicant: TOSHIBA TEC KABUSHIKI KAISHA, Tokyo (JP)

(72) Inventor: Toshiyuki Suzuki, Mishima (JP)

(21) Appl. No.: 15/193,320

(22) Filed: Jun. 27, 2016

(30) Foreign Application Priority Data
Sep. 28, 2015 (JP) 2015-190093

(51) Int. Cl. G06Q 40/00

(52) U.S. Cl. CPC G06Q 40/123

(57) ABSTRACT

An information processing apparatus comprises a transaction history database which stores transaction information which includes transaction history, tax exemption information indicating execution of a tax exemption processing for the transaction in association; a tax exemption sales achievement database which stores totalization information obtained by totaling the transaction history; a totalization module which totals the transaction history for each country in association with the commodity code of the commodity serving as the object of the tax exemption processing according to the transaction information stored in the transaction history database; and an update module which updates the totalization information.

### CROSS-REFERENCE TO RELATED APPLICATION

This application is based upon and claims the benefit of priority from Japanese Patent Application No. 2015-190093, filed Sep. 28, 2015, the entire contents of which are incorporated herein by reference.

### FIELD

Embodiments described herein relate generally to an information processing apparatus.

### BACKGROUND

Conventionally, in a case in which a business person who runs an export article store (duty-free store) sells a sales object such as a commodity to a nonresident such as a foreign tourist, there exists a so-called tax exemption system for exempting taxes such as a consumption tax relating to the sales object under certain conditions. In recent years, “consumables” such as foodstuffs, beverages, medicines, cosmetics and the like can be also regarded as tax exemption objects.

Thus, a technology is disclosed which executes collective determination of a tax exemption condition for commodities to which a transaction processing relating to sales of the commodities is executed and a tax exemption processing for commodities serving as tax exemption objects meeting the tax exemption condition.

However, according to the conventional technology, totalization of tax exemption amount of the commodities serving as the tax exemption objects can be carried out; however, there is a problem that various analysis of the tax exemption by single articles or by nationalities cannot be carried out for the commodities serving as the tax exemption objects.

### DESCRIPTION OF THE DRAWINGS

FIG. 1 is a schematic configuration diagram illustrating a POS system according to an embodiment;

FIG. 2 is a block diagram illustrating the hardware structure of a server;

FIG. 3 is a diagram illustrating an example of the data structure of a commodity master file;

FIG. 4 is a diagram illustrating an example of the data structure of a tax exemption division file;

FIG. 5 is a diagram illustrating an example of the data structure of a tax exemption set value file;

FIG. 6 is a diagram illustrating an example of the data structure of a country/region information master file;

FIG. 7 is a diagram illustrating an example of the data structure of a transaction history database;

FIG. 8 is a diagram illustrating an example of the data structure of a tax exemption sales daily achievement database;

FIG. 9 is a block diagram illustrating the hardware structure of a POS terminal;

FIG. 10 is a functional block diagram illustrating the functional components of a control section of the POS terminal;

FIG. 11 is a flowchart illustrating the flow of a control processing of the POS terminal;

FIG. 12 is a flowchart illustrating the flow of a tax exemption processing;

FIG. 13 is a diagram illustrating an example of a confirmation screen;

FIG. 14 is a diagram illustrating an example of a commodity registration screen;

FIG. 15 is a diagram illustrating an example of an error screen;

FIG. 16 is a diagram illustrating an example of a commodity registration screen;

FIG. 17 is a diagram illustrating an example of a purchase written oath;

FIG. 18 is a diagram illustrating an example of a purchase record slip;

FIG. 19 is a diagram illustrating an example of a receipt;

FIG. 20 is a functional block diagram illustrating the functional components of a control section of the server; and

FIG. 21 is a flowchart illustrating the flow of a control processing of the server.

### DETAILED DESCRIPTION

In accordance with an embodiment, an information processing apparatus comprises a transaction history database configured to store transaction information which includes transaction history at least containing a commodity code, unit price and the number of sales of a commodity transacted through a commodity sales data processing apparatus that carries out a sales registration processing relating to a transaction of the commodity and transaction number for identifying the transaction, tax exemption information indicating that a tax exemption processing is carried out for the transaction through the commodity sales data processing apparatus in association with the transaction number and countries or regions of people who receive the tax exemption processing input at the time of the tax exemption processing; a tax exemption sales achievement database configured to store totalization information obtained by totaling the transaction history for each country or region of the people who receive the tax exemption processing in association with the commodity code of the commodity serving as the object of the tax exemption processing in a predetermined period; a totalization module configured to total the transaction history for each country or region of the people who receive the tax exemption processing in association with the commodity code of the commodity serving as the object of the tax exemption processing on the basis of the transaction information stored in the transaction history database in the predetermined period at a predetermined timing; and an update module configured to update the totalization information in the tax exemption sales achievement database on the basis of a totalization result obtained by the totalization module.

In the embodiment, a POS (Point Of Sales) system is described which is used in an export article store (such as a duty-free store) that sells a sales object used in an ordinary life to a nonresident such as a foreign tourist with a certain method. The embodiment is an application example to a server that concentratedly manages one or more POS terminals arranged in the duty-free store as an information processing apparatus.

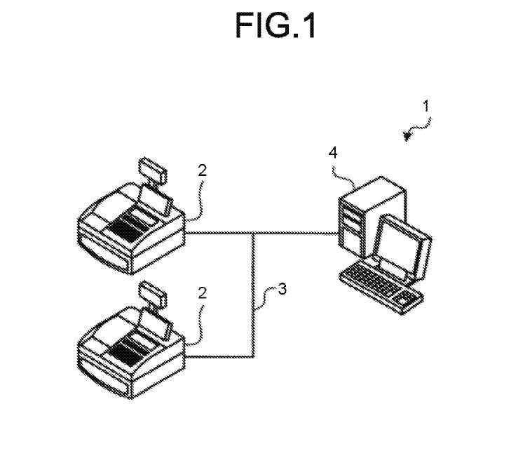

FIG. 1 is a schematic configuration diagram illustrating a POS system 1 according to the embodiment. As shown in FIG. 1, the POS system 1 comprises a plurality of (two in FIG. 1) POS terminals 2 serving as the commodity sales data processing apparatuses and an server 4 serving as the information processing apparatus connected with these POS terminals 2 through a network 3 such as an LAN (Local Area Network) to concentratedly manage them. Although two POS terminals 2 are shown, any number of POS terminals can be employed in other embodiments.

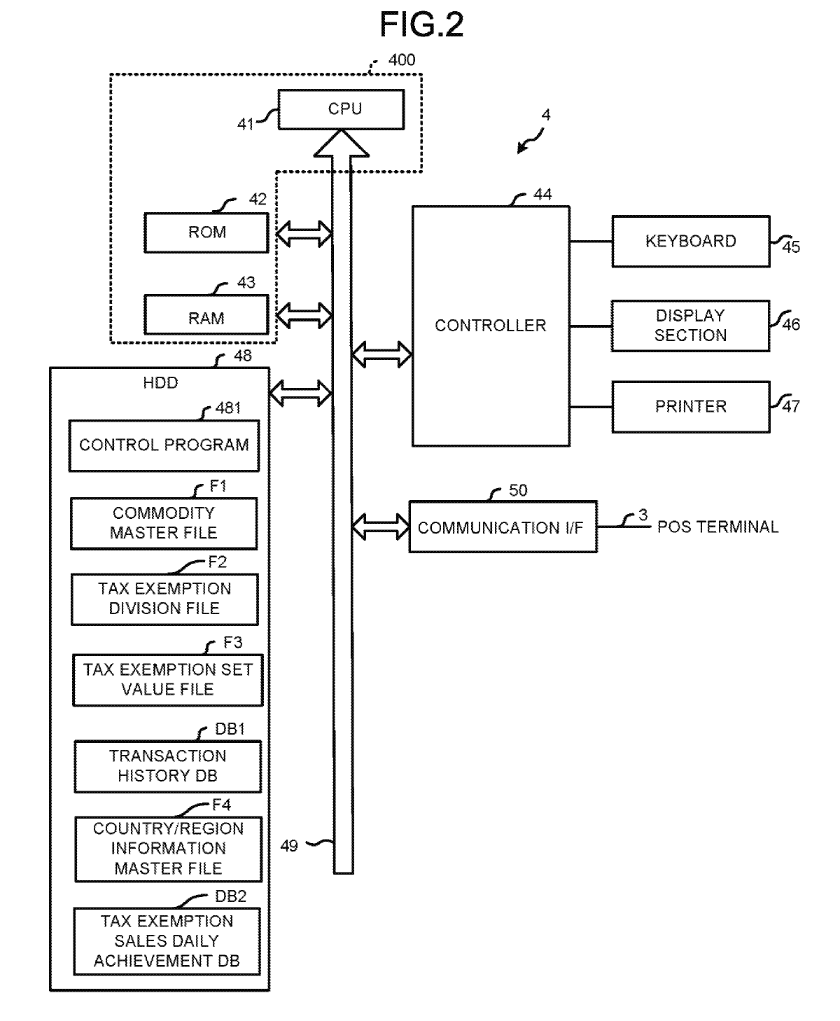

The server 4 controls the whole of the POS system 1. FIG. 2 is a block diagram illustrating the hardware structure of the server 4. The server 4 includes a control section 400 with the computer structure composed of a CPU (Central Processing Unit) 41, a ROM (Read Only Memory) 42 and a RAM (Random Access Memory) 43.

The control section 400 is connected with a communication I/F (interface) 50 via a bus line 49. On-line communication is mutually carried out between the server 4 and a plurality of POS terminals 2 via a communication I/F 50 and the network 3 (refer to FIG. 1). Further, the control section 400 is connected with a keyboard 45, a display section 46 and a printer 47 via the bus line 49 and a controller 44. Further, the control section 400 is connected with an HDD (Hard Disk Drive) 48 via the bus line 49. The HDD 48 stores various control programs 481 for enabling the control section 400 to operate. The HDD 48 stores a commodity master file F1, a tax exemption division file F2, a tax exemption set value file F3, a country/region information master file F4, and/or any other files required to support tax exempt sales transactions.

Further, the HDD 48 holds a transaction history database (DB) DB1 as a database for storing transaction information relating to a transaction to which a sales registration processing is carried out by the POS terminal 2. Furthermore, the HDD 48 holds a tax exemption sales daily achievement database (DB) DB2 as a tax exemption sales achievement database for storing information relating to a commodity serving as an object of an under-mentioned tax exemption processing by the POS terminal 2.

The control programs 481 executed by the server 4 of the embodiment may be recorded in a computer-readable recording medium in the form of installable or executable file to be provided. Such a recording medium is a CD-ROM, an FD (Flexible Disk), a CD-R, a DVD (Digital Versatile Disk) and the like.

Furthermore, the control programs 481 executed by the server 4 of the embodiment may be stored in a computer connected with a network such as an Internet and downloaded via the network to be supplied or may be supplied or distributed via the network such as the Internet.

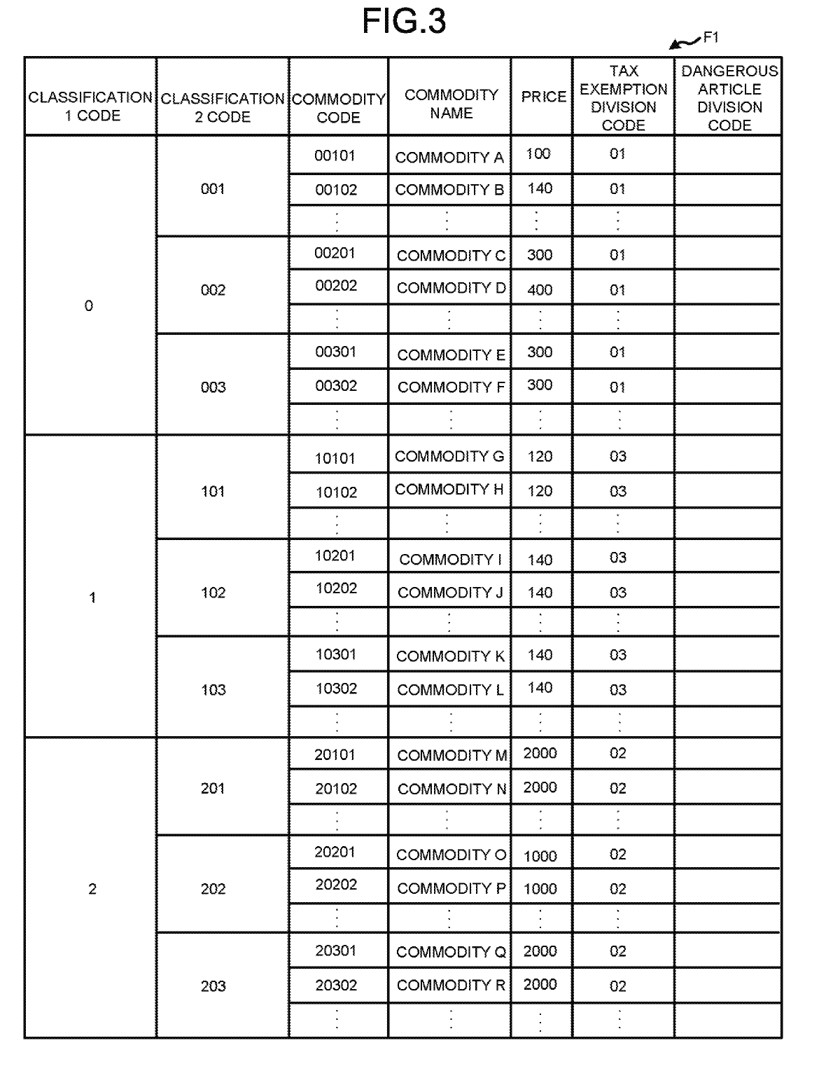

Next, the commodity master file F1 and a commodity classification (classification) set in the commodity master file F1 are described. FIG. 3 is a diagram illustrating an example of the data structure of the commodity master file F1. As shown in FIG. 3, in the commodity master file F1, commodity information such as a commodity name and a commodity price (unit price), classification codes (classification 1 code and classification 2 code), a tax exemption division code and a dangerous article division code is set in association with a commodity code (commodity identification information) of each commodity serving as a sales registration object. A dangerous article division code is applied to a commodity such as spray and the like required to be cautious in handling which is prohibited from being brought to the airplane.

The commodities are classified according to a plurality of classification codes and those plural classifications can be hierarchically constructed.

In other words, as shown in FIG. 3, the commodities can be classified into a plurality of classifications according to a classification 1 (high-order classification) which is a rough classification. Further, each classification 1 is further classified in detail according to a classification 2 (lower-order classification) which is more detailed classification. The high-order classification 1 is classified into a plurality of classifications according to the classification 2 the order of which is lower than the classification 1 and includes at least one lower-order classification 2.

From the point of view of the hierarchical construction, the commodity code associated with each commodity can be regarded as a classification the order of which is lower than the classification 2. The commodity code can be regarded as the most detailed classification, in other words, the lowest-order classification. Although not discussed, one or more intermediate order classifications can be optionally employed.

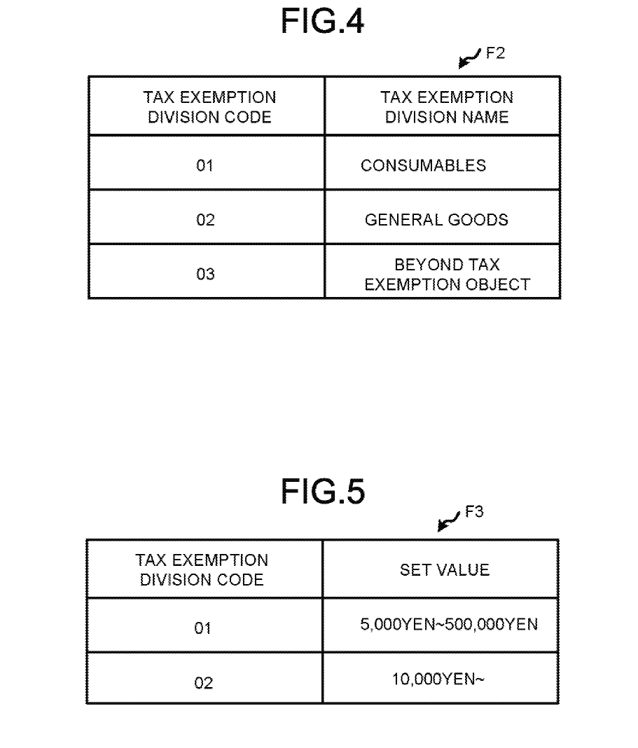

Next, the tax exemption division file F2 is described. FIG. 4 is a diagram illustrating an example of the data structure of the tax exemption division file F2. As shown in FIG. 4, in the tax exemption division file F2, tax exemption division names are set in association with the tax exemption division codes. The tax exemption division names refer to “consumables”, “general goods” and “beyond tax exemption object”. The “consumables” serving as the tax exemption objects of which the taxes relating to articles sold to a nonresident such as a foreign tourist are exempted refer to foodstuffs, beverages, medicines, cosmetics and the like. The “general goods”, which are also tax exemption objects to any purchaser (foreign or domestic), refer to commodities used in the ordinary life other than the consumables. The “beyond tax exemption object” refers to a non-tax exemption object which is not the tax exemption object. The tax exemption division code of the “consumables” is “01”. The tax exemption division code of the “general goods” is “02”. The tax exemption division code of the “beyond tax exemption object” is “03”.

Next, the tax exemption set value file F3 is described. FIG. 5 is a diagram illustrating an example of the data structure of the tax exemption set value file F3. As shown in FIG. 5, a set value is set in the tax exemption set value file F3 in association with the tax exemption division code. The set value is a criterion for executing the sales registration as tax exemption in each division. In the example shown in FIG. 5, the set value for consumables of which the tax exemption division code is “01” is 5,000 Yen˜500,000 Yen. Further, the set value for general goods (articles used in the ordinary life other than the consumables) of which the tax exemption division code is “02” is an amount above 10,000 Yen.

The control section 400 of the server 4 according to the embodiment delivers the commodity master file F1, the tax exemption division file F2 and the tax exemption set value file F3 to the POS terminal 2 at a predetermined timing through the execution of the control program 481.

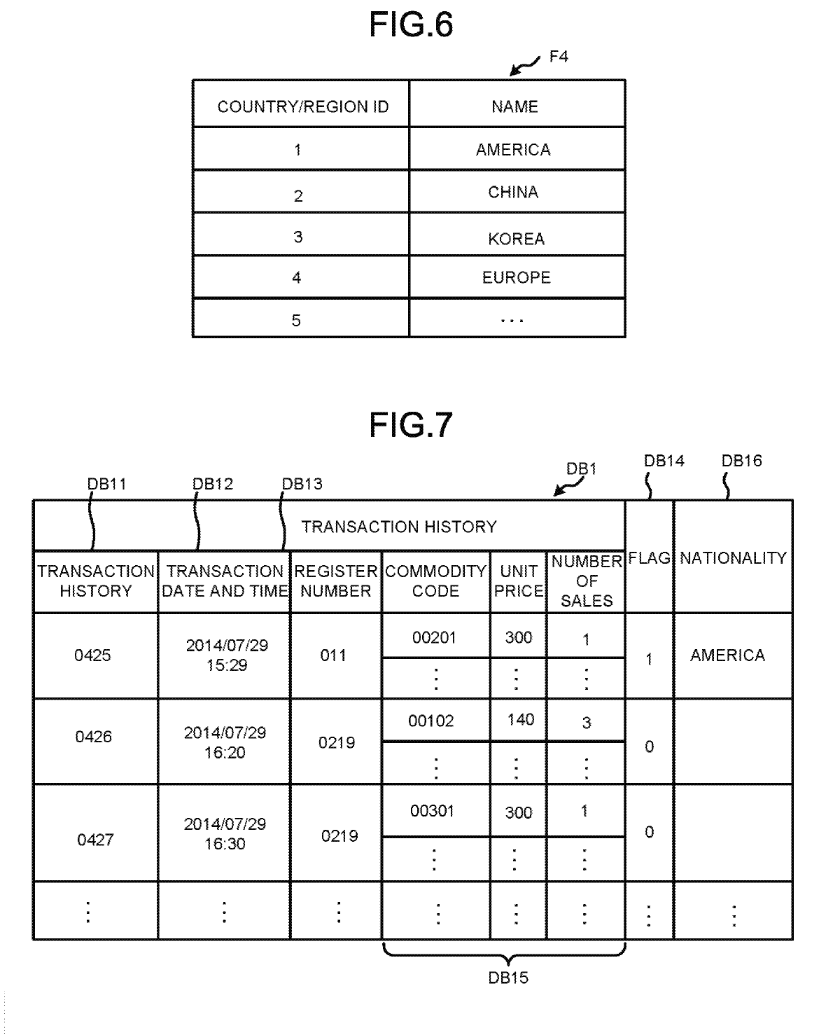

FIG. 6 is a diagram illustrating an example of the data structure of the country/region information master file F4. As shown in FIG. 6, in the country/region information master file F4, names of countries/regions are set in association with country/region IDs of countries or regions of people who receive the tax exemption processing.

Next, the transaction history database DB1 is described. FIG. 7 is a diagram illustrating an example of the data structure of the transaction history database DB1. As shown in FIG. 7, in the transaction history database DB1, the transaction information of the transaction processed by each of the POS terminals 2 is stored as transaction history. The transaction history contains transaction number (stored in a transaction number section DB11) for identifying each transaction, transaction date and time (stored in a transaction date and time section DB12) when the transaction is carried out and register number (stored in a register number section DB13) for identifying the POS terminal 2 that processes the transaction. Further, the transaction history contains the commodity code, the unit price and the number of sales of each sales-registered commodity (stored in a commodity information section DB15).

Further, in the transaction history database DB1, a flag (stored in a flag section DB14) is set in association with the transaction number. On the basis of the flag stored in the flag section DB14, it is determined whether or not the under-mentioned tax exemption processing is carried out for the transaction. In the example shown in FIG. 7, the transaction of which the flag is “0” refers to a transaction to which the tax exemption processing is not carried out, and the transaction of which the flag is “1” refers to a transaction to which the tax exemption processing is carried out. In FIG. 7, the transaction of transaction number “0425” is subjected to the tax exemption processing, and the transactions of transaction number “0426” and transaction number “0427” are not subjected to the tax exemption processing. Further, the transaction history database DB1 plays a role of an electronic journal that stores data of the transaction history.

Furthermore, in the transaction history database DB1, nationality (stored in a nationality section DB16) is set in association with the transaction number. The nationality stored in the nationality section DB16, which is described later in detail, is the nationality of a nonresident such as a foreign tourist (people who receive the tax exemption processing) read from a passport or other official document at the time of the tax exemption processing.

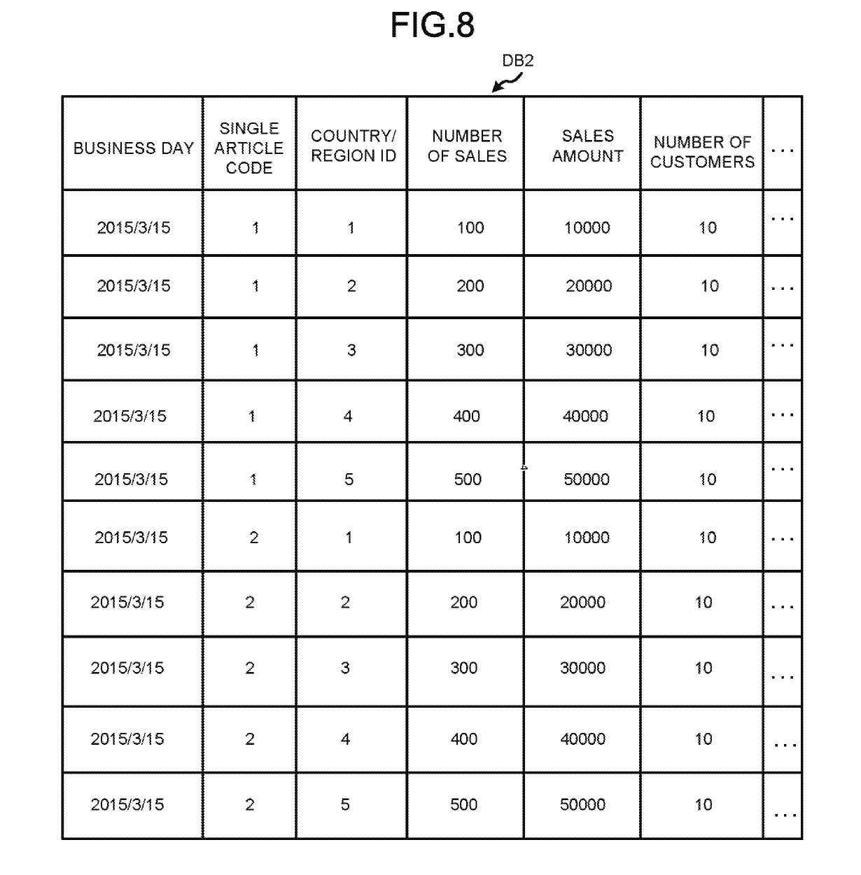

Next, the tax exemption sales daily achievement database DB2 is described. FIG. 8 is a diagram illustrating an example of the data structure of the tax exemption sales daily achievement database DB2. As shown in FIG. 8, in the tax exemption sales daily achievement database DB2, the country/region ID indicating the country or the region of the nonresident (people who receive the tax exemption processing) such as the foreign tourist, the number of sales of each region, sales amount and the number of customers are stored by day in association with a single article code (commodity code) of the commodity serving as an object of the under-mentioned tax exemption processing by the POS terminal 2.

In the present embodiment, the daily tax exemption sales achievement of the commodities serving as the objects of the tax exemption processing is totaled; however, the present invention is not limited to this, and weekly or monthly tax exemption sales achievement may be totaled.

Next, the POS terminal 2 is described. The POS terminal 2, assigned with a unique register number, is arranged at a settlement location. The POS terminal 2 is used to carry out the transaction processing on the basis of the commodity code input by an operator (cashier).

The POS terminal 2 carries out the transaction processing relating to sales of the commodities sold in the store. Further, the transaction processing refers to a processing of combining a sales registration processing and a settlement processing.

The sales registration processing refers to a processing of optically reading a code symbol such as a barcode attached to the sold commodity to input the commodity code, displaying the commodity name and the price (commodity information) of the commodity read on the basis of the input commodity code and storing the commodity information in a buffer.

The settlement processing refers to a processing of displaying total amount relating to the transaction on the basis of the commodity information stored in the buffer along with the sales registration processing, a processing of calculating change amount on the basis of deposit amount received from the customer to display the change amount, a processing of instructing a change dispensing machine to dispense the change amount and a processing of issuing a receipt on which the commodity information and the settlement information (total amount, deposit amount and change amount) are printed.

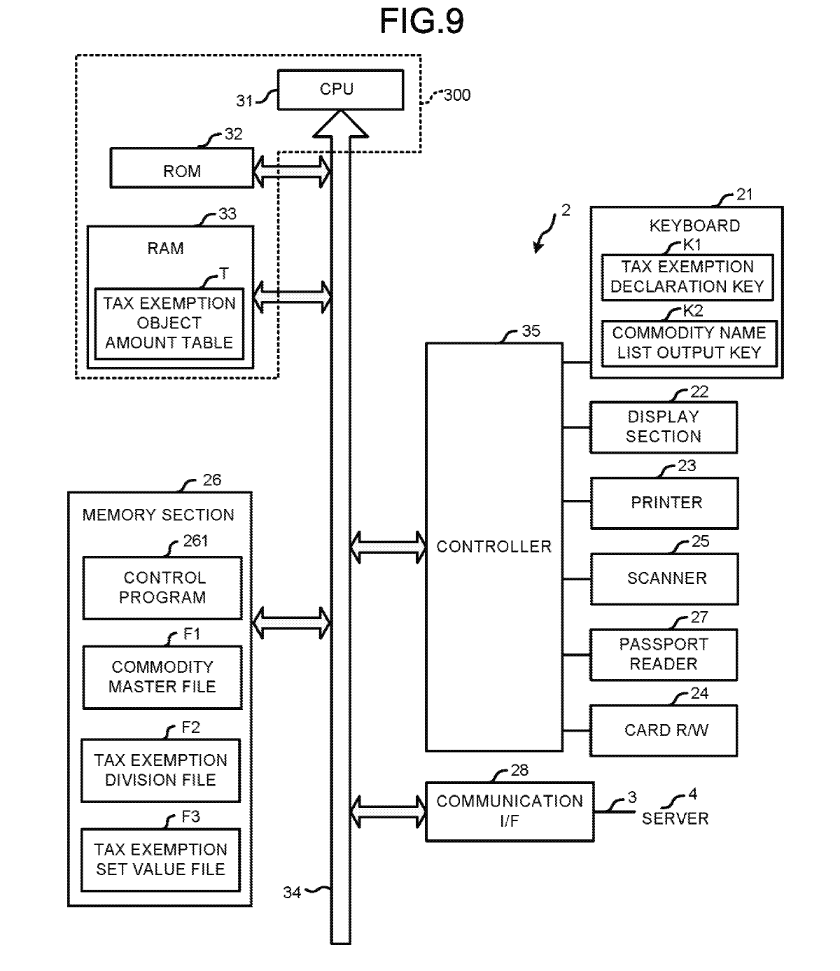

FIG. 9 is a block diagram illustrating the hardware structure of the POS terminal 2. As shown in FIG. 9, the POS terminal 2 includes a control section 300 with the computer structure composed of a CPU 31, a ROM 32 and a RAM 33. The CPU 31 executes various arithmetic processing to control each section. The ROM 32 fixedly stores fixed data. The RAM 33 stores variable data in a rewritable manner and is used as a work area. The CPU 31, the ROM 32 and the RAM 33 are connected via a bus line 34.

A below-mentioned tax exemption object amount table T for totaling tax exemption object amount is formed in the RAM 33.

In the POS terminal 2, a keyboard 21, a display section 22 serving as a liquid crystal display device on the surface of which a touch panel is arranged, a printer 23, a card reader/writer (R/W) 24, a scanner 25 for optically reading the code symbol such as the barcode or a two-dimensional code attached to the commodity and a passport reader 27 are connected to a controller 35.

The keyboard 21 is arranged with various keys in each block. Various keys include, for example, numeric keys for inputting the commodity code, the amount and the like, a subtotal key for declaring calculation of sales total amount, a cash total key for declaring close of the transaction with cash in the settlement processing, a PLU key for designating various commodities, a determination key for determining numeric input by the numeric keys and a clear key.

Further, the keyboard 21 includes a tax exemption declaration key K1 and a commodity name list output key K2. The tax exemption declaration key K1 is an operator for declaring the execution of the tax exemption processing for the transaction. The commodity name list output key K2 is an operator for instructing the output of a list (commodity name list) of the commodities serving as the tax exemption objects.

The passport reader 27 is a reading device for reading information held in the passport or other official document. In the embodiment, the passport reader 27 has an OCR (Optical Character Recognition) function for optically reading character strings recorded in the passport.

The control section 300 is connected with the keyboard 21, the display section 22, the printer 23, the card reader/writer 24, the scanner 25 and the passport reader 27 described above via the bus line 34 and the controller 35. Further, the control section 300 is connected with a memory section 26 serving as a storage device via the bus line 34. The memory section 26, constituted with an HDD (Hard Disk Drive), a flash memory and the like, maintains storage content even if the power source is cut off. The keyboard 21, the display section 22, the printer 23, the card reader/writer 24, the scanner 25, the memory section 26 and the passport reader 27 are controlled by the control section 300.

The POS terminal 2 further includes a communication I/F (interface) 28 for carrying out data communication with the server 4 serving as a host device via the network 3 arranged in the store. The communication interface 28 is also connected with the bus line 34.

Incidentally, in the memory section 26 of the POS terminal 2, a control program 261 such as an operating system, various computer programs and the like and various data files are stored. As the data files, there are the commodity master file F1, the tax exemption division file F2 and the tax exemption set value file F3 distributed from the server 4.

The control program 261 executed by the POS terminal 2 of the embodiment may be recorded in a computer-readable recording medium such as a CD-ROM, an FD (Flexible Disk), a CD-R, a DVD (Digital Versatile Disk) and the like in the form of installable or executable file to be provided.

Further, the control program 261 executed by the POS terminal 2 of the embodiment may be stored in a computer connected with a network such as an Internet and downloaded via the network to be supplied or may be supplied or distributed via the network such as the Internet.

Further, the control program 261 executed by the POS terminal 2 of the embodiment may be incorporated into the ROM before the POS system is engaged for purchase processing.

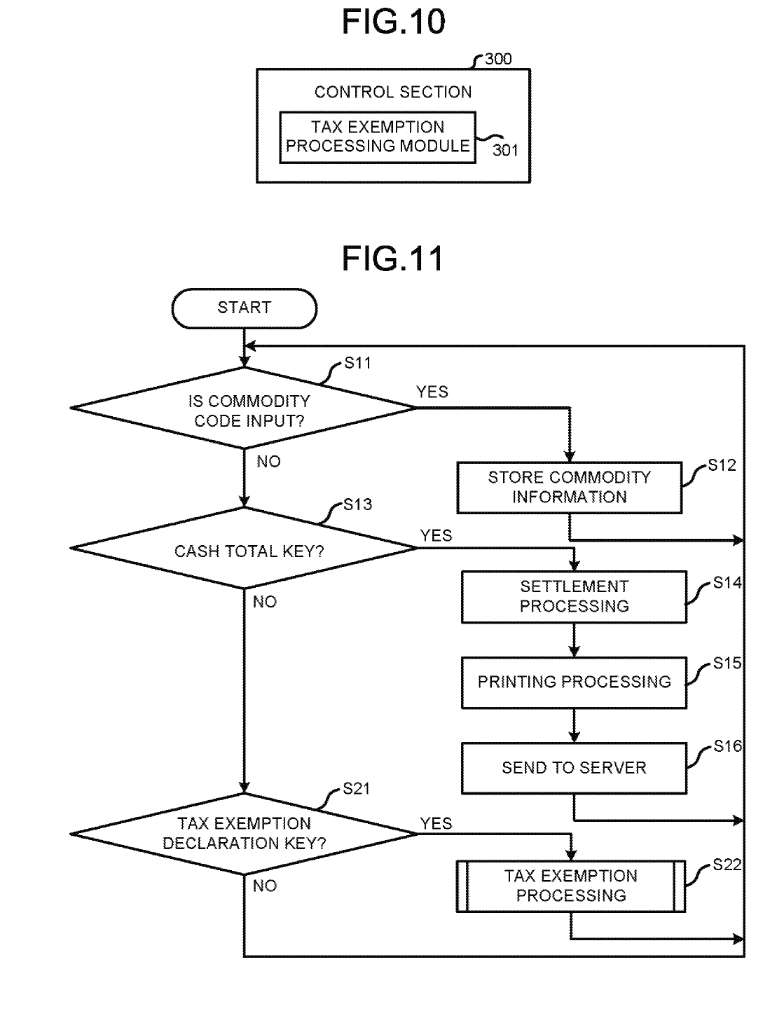

Next, with reference to FIG. 10-FIG. 19, a control processing executed by the control section 300 of the POS terminal 2 of the embodiment according to the control program 261 is described.

FIG. 10 is a functional block diagram illustrating the functional components of the control section 300 of the POS terminal 2. The control section 300 functions as a tax exemption processing module 301 according to the control program 261 stored in the memory section 26.

The tax exemption processing module 301 has a function of carrying out a tax exemption processing for exempting taxes from the amount of the commodities serving as the tax exemption objects.

FIG. 11 is a flowchart illustrating the flow of the control processing of the POS terminal 2. As shown in FIG. 11, the control section 300 of the POS terminal 2 determines whether or not the commodity code for specifying the commodity is input with the use of the scanner 25 (Act S11). If it is determined that the commodity code is input (Yes in Act S11), the control section 300 executes the sales registration processing for calculating registration amount of the commodity on the basis of the commodity information such as the commodity name, the unit price and the like obtained by retrieving the commodity master file F1 in response to the input commodity code. Then, the control section 300 stores the commodity information of the commodity to which the sales registration processing is carried out in the RAM 33 (Act S12).

On the other hand, if it is determined that the commodity code is not input (No in Act S11), the control section 300 determines whether or not the cash total key arranged on the keyboard 21 for declaring the termination of the transaction is operated (Act S13). If it is determined that the cash total key is operated (Yes in Act S13), the control section 300 executes the settlement processing for calculating the total amount on the basis of the registration amount and the commodity information of the commodity for the transaction (Act S14). The settlement processing executed in Act S14 is a settlement processing for calculating the total amount containing amount of tax of the consumption tax and the like taxed on the commodity purchased by the customer.

Then, the control section 300 prints the commodity information and the settlement information of the commodity to which the settlement processing is carried out on a receipt paper to issue the receipt (Act S15). The transaction number for specifying the transaction is printed on the issued receipt in the form of the barcode. Then, the control section 300 sends the transaction information (the transaction number, transaction date and time, the register number, the commodity code, the unit price, the number of sales and the like) of the transacted commodity to the server 4 (Act S16). The server 4 stores the received information in the transaction history database DB1. Specifically, the control section 400 of the server 4 stores the transaction number in the transaction number section DB11. The control section 400 stores the transaction date and time in the transaction date and time section DB12. The control section 400 stores the register number of the POS terminal 2 that carries out the transaction processing in the register number section DB13. The control section 400 stores the commodity code, the unit price and the number of sales of the transacted commodity in the commodity information section DB15. Further, the control section 400 stores the flag “0” indicating that the tax exemption processing is not carried out for the transaction in the flag section DB14 in association with the transaction number of the transaction.

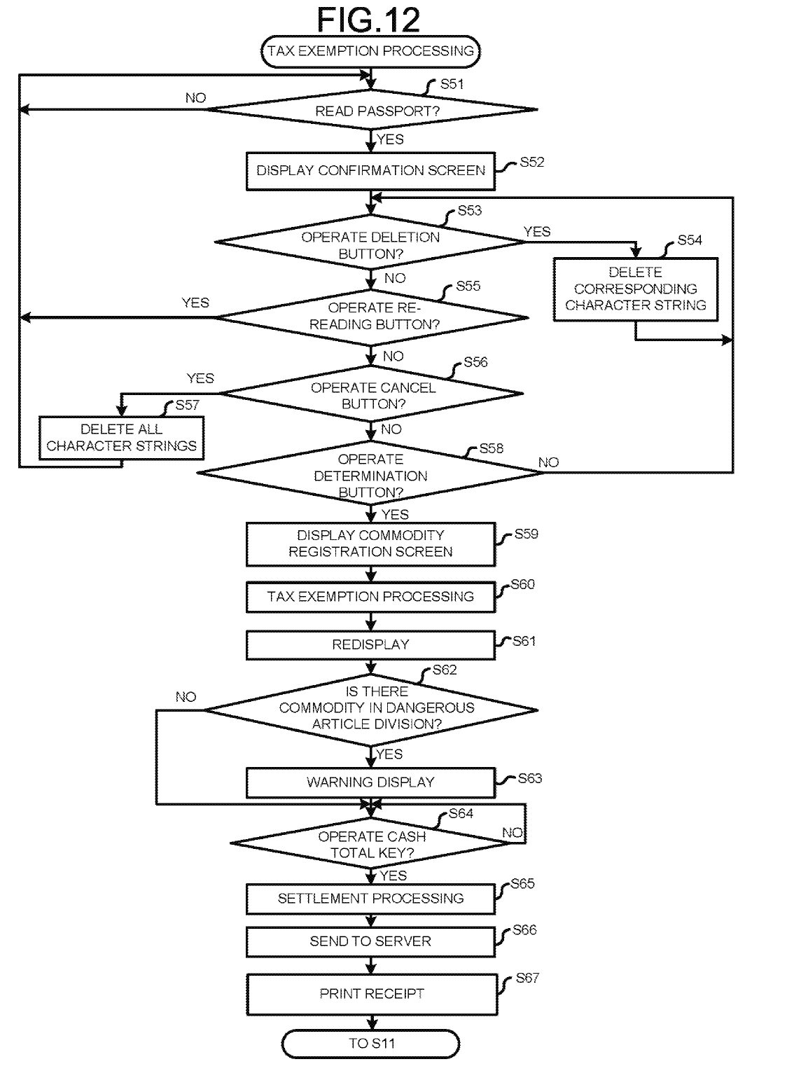

On the other hand, if it is determined that the cash total key is not operated (No in Act S13), the control section 300 determines whether or not the tax exemption declaration key K1 is operated (Act S21). If it is determined that the tax exemption declaration key K1 is operated (Yes in Act S21), it is regarded that there is a declaration of the tax exemption processing, the control section 300 executes the tax exemption processing shown in FIG. 12 (Act S22).

(Tax Exemption Processing)

Herein, with reference to FIG. 12-FIG. 19, the tax exemption processing executed in Act S22 at the time the tax exemption declaration key K1 is operated is described in detail. FIG. 12 is a flowchart illustrating the flow of the tax exemption processing. In FIG. 12, the control section 300 enables the passport reader 27 to operate. The control section 300 determines whether or not the passport reader 27 reads the specific character strings from the passport (Act S51). As the character strings, for example, passport number, full name, nationality, birth date, date is issue, date of expiration, and the like are exemplified. The control section 300 controls the display section 22 to display that the passport is being read until the specific character strings are read from the passport.

The control section 300 enables the display section 22 to display a guide screen (not shown) for prompting the reading of the passport. The operator of the POS terminal 2 opens a page on which matters relating to the tax exemption system are recorded in the passport presented from the customer (nonresident) and holds the page over the passport reader 27. According to the operation, the control section 300 reads the specific character strings from the passport.

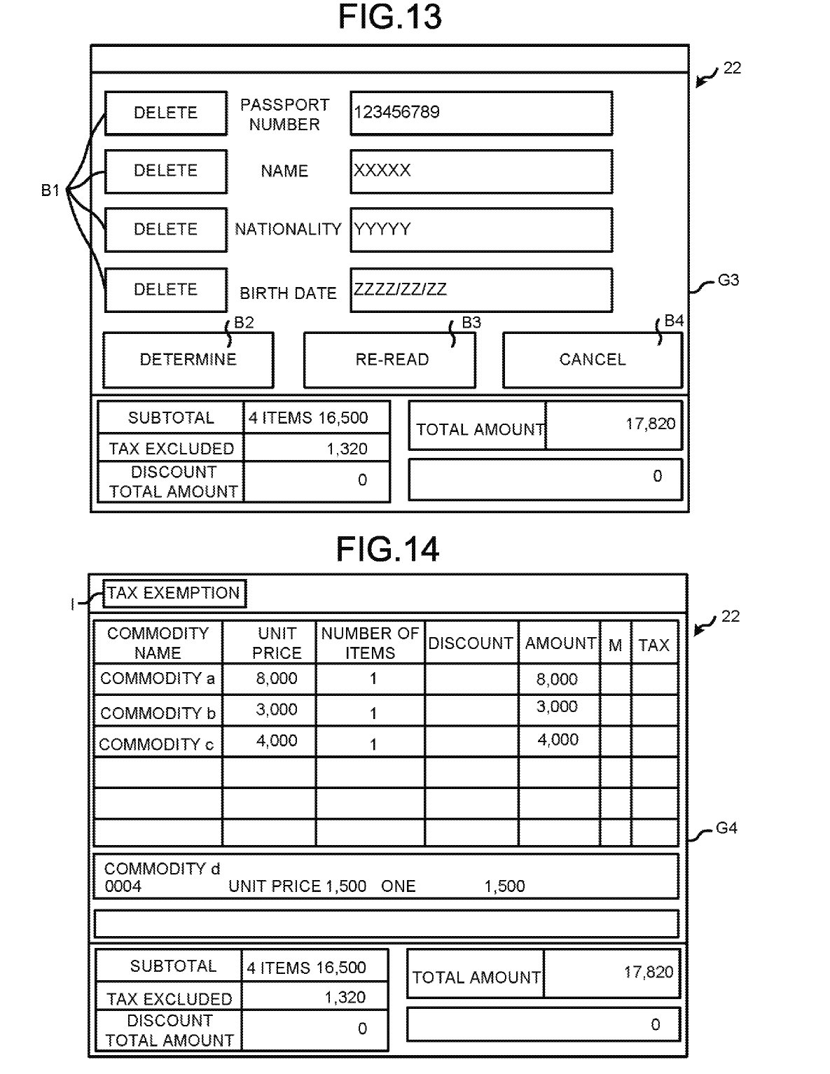

The control section 300 stands by until the character strings are read (No in Act S51). If it is determined that the character strings are read (Yes in Act S51), the control section 300 displays a confirmation screen G3 (FIG. 13) on the display section 22 to enable the character strings read in Act S51 to be confirmed (Act S52).

FIG. 13 is a diagram illustrating an example of the confirmation screen. As shown in FIG. 13, the character strings read in Act S51 are displayed by each item (matter) on the confirmation screen G3. In FIG. 13, a case of reading the character strings of the items of the passport number, the full name, the nationality and the birth date among the items recorded in the passport is exemplified.

Herein, a deletion button B1 is arranged in association with each item on the confirmation screen G3. The control section 300 determines the operation/non-operation of the deletion button B1 (ACT S53). If it is determined that the deletion button B1 is operated (Yes in ACT S53), the control section 300 deletes the read character strings corresponding to the items (ACT S54), and returns to the processing in ACT S53. For example, in a case in which any one of the character strings of the items read in ACT S51 is mistaken, the wrong character string can be deleted through operating the deletion button B1. Further, the control section 300 displays the confirmation screen G3 on which the character string of the item deleted in ACT S54 is blank.

The control section 300 displays a determination button B2, a re-reading button B3 and a cancel button B4 corresponding to a confirmation receiving module of the embodiment on the confirmation screen G3. If it is determined that the deletion button B1 is not operated (No in ACT S53), the control section 300 determines the operation/non-operation of the re-reading button B3 (ACT S55). If it is determined that the re-reading button B3 is operated (Yes in ACT S55), the control section 300 returns to the processing in ACT S51 to read the character string from the passport again. Further, the character string read last time is deleted along with the operation of the re-reading button B3.

If it is determined that the re-reading button B3 is not operated (No in ACT S55), the control section 300 determines the operation/non-operation of the cancel button B4 (ACT S56). If it is determined that the cancel button B4 is operated (Yes in ACT S56), the control section 300 deletes all the read character strings (ACT S57) and returns to the processing in ACT S51. Along with the operation of the cancel button B4, the control section 300 switches the display screen of the display section 22 from the confirmation screen G3 to a commodity registration screen (not shown).

If it is determined that the cancel button B4 is not operated (No in ACT S56), the control section 300 determines the operation/non-operation of the determination button B2 (ACT S58). If it is determined that the determination button B2 is operated (Yes in ACT S58), the control section 300 displays a commodity registration screen G4 (refer to FIG. 14) (ACT S59). Next, the control section 300 (tax exemption processing module 301) executes the tax exemption processing (ACT S60). If it is determined that the determination button B2 is not operated (No in ACT S58), the control section 300 returns to the processing in ACT S53.

FIG. 14 shows an example of the commodity registration screen G4. In FIG. 14, a tax exemption indicator I indicating “tax exemption” is displayed on the commodity registration screen G4. The control section 300 displays the tax exemption indicator I on the commodity registration screen G4 to notify the operator that it is the tax exemption declaration transaction.

Herein, the tax exemption processing in ACT S60 is described. First, for the registered commodity of which the registration is already completed, the control section 300 refers to the tax exemption division code in the commodity master file F1 to determine the tax exemption object commodity serving as the tax exemption object. If there is a tax exemption object commodity, the control section 300 executes an addition processing for adding the tax exemption object amount of each registered commodity group (general goods group/consumables group) serving as a tax exemption object to the tax exemption object amount table T.

The correspondence of the tax exemption object commodities based on the tax categories is executed as follows.

If the registered commodity serving as the tax exemption object is a tax-included commodity, the control section 300 adds tax-excluded amount of the registration amount to the tax exemption object amount table T as the tax exemption object amount. More specifically, in the case of the tax-included commodity, the control section 300 sets the difference between the registration amount before the tax exemption and the registration amount after the tax exemption as the tax exemption amount. For example, • unit price before the tax exemption 1,080 Yen−unit price after the tax exemption 1,000 Yen→tax exemption amount 80 Yen

If the registered commodity serving as the tax exemption object is the tax-excluded commodity, the control section 300 adds the registration amount as the tax exemption object amount to the tax exemption object amount table T. More specifically, in the case of the tax-excluded commodity, the control section 300 sets the tax-excluded amount as the tax exemption amount with respect to the registration amount.

Further, if the registered commodity is a commodity beyond tax exemption object, the control section 300 does not add the registration amount as the tax exemption object amount to the tax exemption object amount table T.

Next, the control section 300 determines whether or not the tax exemption object amount in the tax exemption object amount table T meets the set value (reference amount) in the tax exemption set value file F3. In the tax exemption set value file F3 of the embodiment, the set value of foodstuffs, beverages, medicines, cosmetics or other consumables is 5,000 Yen˜500,000 Yen. The set value of general goods (articles used in the ordinary life other than the consumables) is greater than 10,000 Yen.

If it is determined that the tax exemption object amount of the consumables meets the set value (5,000 Yen˜500,000 Yen), the control section 300 executes the tax exemption processing for exempting the tax relating to the tax exemption object amount. If it is determined that the tax exemption object amount of the general goods (articles used in the ordinary life other than the consumables) meets the set value (amount greater than 10,000 Yen), the control section 300 executes the tax exemption processing for exempting the tax relating to the tax exemption object amount.

The control section 300 executes an error display on the display section 22 in a case in which the tax exemption object amount of the consumables in the tax exemption object amount table T is greater than the upper limit value (500,000 Yen) of the set value.

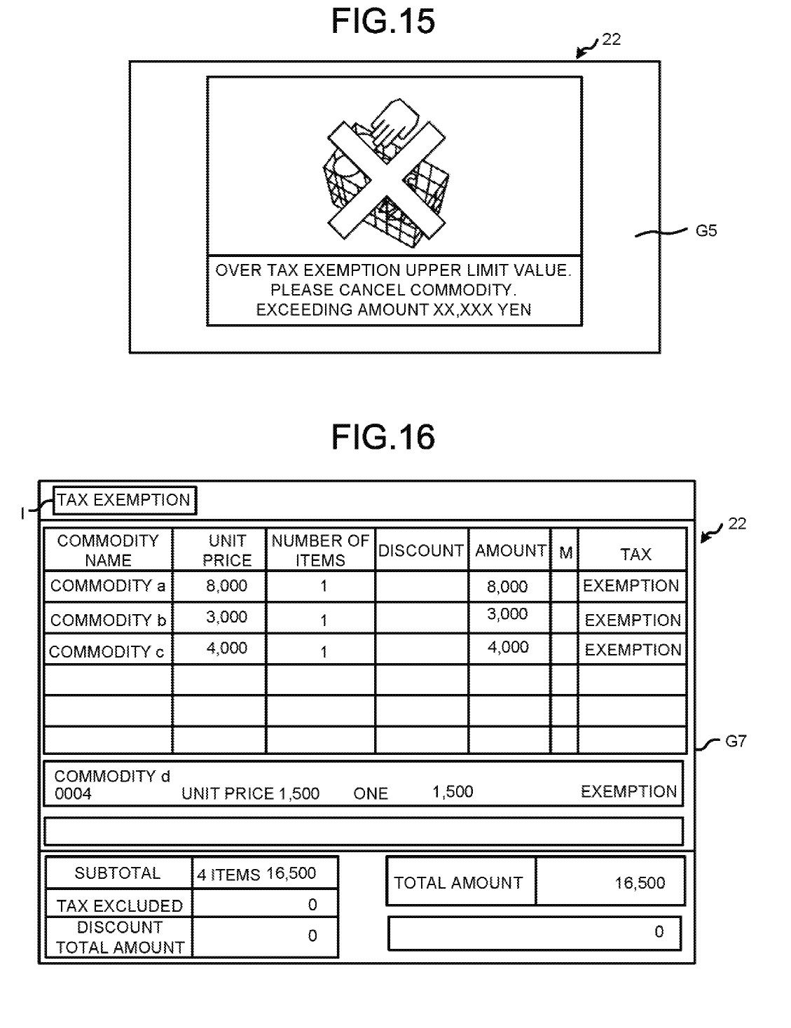

FIG. 15 is a diagram illustrating an example of the error screen. As shown in FIG. 15, at the time of declaring the tax exemption through the operation of the tax exemption declaration key K1, the control section 300 displays a screen indicating “Over the tax exemption upper limit value. Please cancel the commodity. Exceeding amount XX, XXX Yen” as the error screen G5. The control section 300 deletes the error screen in a case in which the clear key on the keyboard 21 is operated.

After such a tax exemption processing is executed, the control section 300 displays the commodity registration screen again (ACT S61). Herein, FIG. 16 is a diagram illustrating an example of a commodity registration screen G7 after the redisplay. As shown in FIG. 16, the commodity registration screen G7 after the redisplay sets the amount of tax to “0 Yen” through exempting the tax by the tax exemption processing. As shown in FIG. 16, the commodity registration screen G7 after the redisplay sets the total display amount to the amount (amount obtained by subtracting the exempted tax amount) after the tax exemption processing. Further, the commodity registration screen G7 after the redisplay displays a character “exemption” on a tax exemption object completion commodity, in other words, a commodity to which the tax exemption processing has been executed.

Next, the control section 300 refers to the commodity master file F1 to determine the presence/absence of a commodity in a dangerous goods division in the tax exemption object commodity (ACT S62). If it is determined that there is the commodity in the dangerous goods division (Yes in ACT S62), the control section 300 displays a warning screen (not shown) on the display section 22 in a pop-up manner (ACT S63). Further, the control section 300 deletes the warning screen if the clear key on the keyboard 21 is operated. If it is determined that there is no commodity in the dangerous goods division (No in ACT S62), the control section 300 does not execute the processing in ACT S63.

Next, the control section 300 determines whether or not the cash total key is operated (ACT S64). The control section 300 stands by until the cash total key is operated (No in ACT S64). If it is determined that the cash total key is operated (Yes in ACT S64), the control section 300 executes the settlement processing for calculating the total amount on the basis of the registration amount and the commodity information of the commodity for the transaction (ACT S65). The settlement processing executed in ACT S65 calculates the total amount not containing the amount of tax without adding the tax of the consumption tax and the like for the sold commodity as the tax exemption processing is executed.

Then, the control section 300 sends the transaction information (the transaction number, the transaction date and time, the register number, the commodity code, the unit price, the number of sales and the like) and the tax exemption information of the commodity to which the settlement processing is carried out and the country or region of people who receive the tax exemption processing to the server 4 (ACT S66). The server 4 receiving the transaction information stores the received information in the transaction history database DB1. Specifically, the control section 400 of the server 4 stores the transaction number in the transaction number section DB11. The control section 400 stores the transaction date and time in the transaction date and time section DB12. The control section 400 stores the register number of the POS terminal 2 that executes the transaction processing in the register number section DB13. The control section 400 stores the commodity code, the unit price and the number of sales of the transacted commodity in the commodity information section DB15. The control section 400 stores the flag “1” indicating that the tax exemption processing is executed for the transaction in the flag section DB14 in association with the transaction number of the transaction. Further, the control section 400 stores the nationality of the nonresident such as the foreign tourist read from the passport at the time of the tax exemption processing in the nationality section DB16 in association with the transaction number of the transaction.

Next, the control section 300 prints the commodity information, the settlement information and the tax exemption amount of the commodity to which the settlement processing is carried out on the receipt paper to issue the receipt (ACT S67).

In the processing in ACT S67, in the case of the transaction to which the tax exemption processing is carried out, the control section 300 prints, for example, one purchase written oath, two purchase record slips and one receipt.

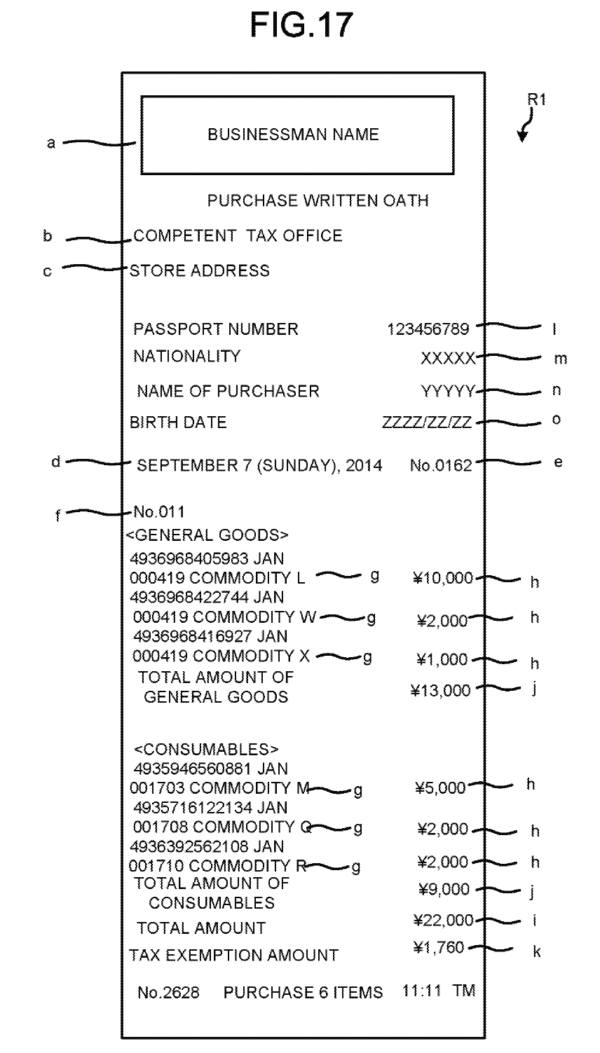

First, the purchase written oath is described. FIG. 17 is a diagram illustrating an example of a purchase written oath R1. The purchase written oath R1 is a document used to record the fact of the purchase of the tax exemption article. The purchase written oath R1 is added in a document (purchaser written oath) as a duplicate copy reserved at the store to be presented to the businessman who runs the duty-free store.

As shown in FIG. 17, the purchase written oath R1 includes a full name or name a of the businessman who runs the duty-free store, a competent tax office name b, a store address of the duty-free store c, transaction date d, transaction number e, register number f, details of the commodity (commodity name g, quantity and price h of each commodity name), total amount i of all the articles, total amount j of the general goods, total amount j of the consumables and tax exemption amount k.

The purchase written oath R1 includes a column at which the character string of each item confirmed on the confirmation screen G3 is printed. Specifically, character strings of the following items confirmed on the confirmation screen G3 are printed in the purchase written oath R1.
passport number . . . l
nationality of the purchaser . . . m
full name of the purchaser . . . n
birth date of the purchaser . . . o

Further, only the name of the item (character string) deleted through the operation of the deletion button B1 on the confirmation screen G3 is printed and the item is directly written on the document (purchase written oath). The layout of the purchase written oath R1 is not limited to the example in FIG. 17. For example, a pledge of outputting the commodity after the purchase (in the case of the consumables, a pledge of outputting the commodity within 30 days from the purchase day) or a signature column of the purchaser may be printed.

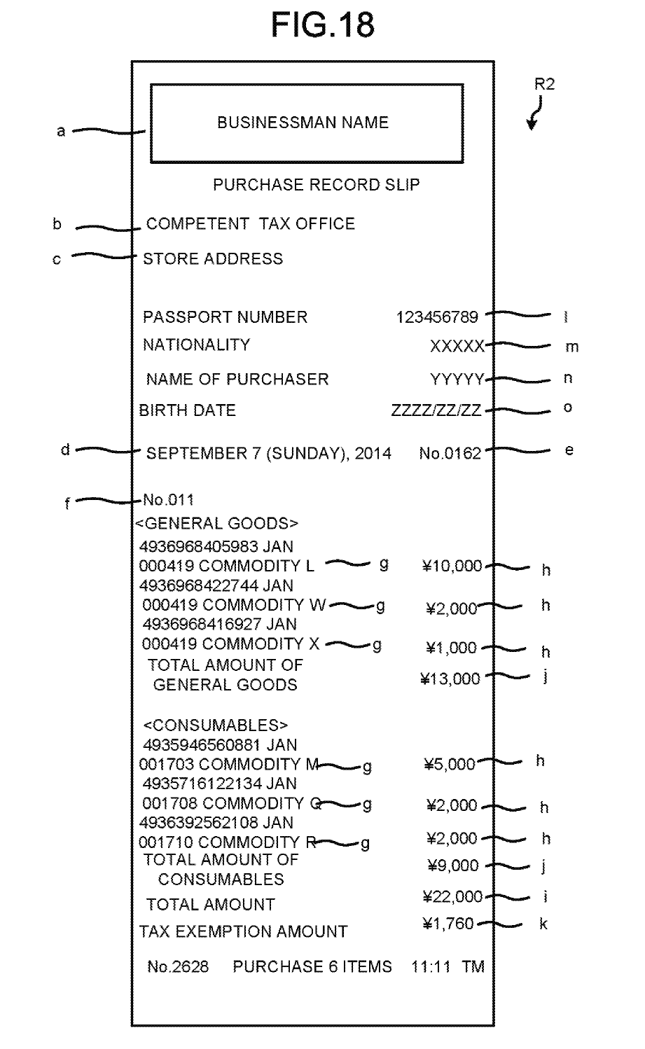

Next, the purchase record slip is described. FIG. 18 is a diagram illustrating an example of a purchase record slip R2. The purchase record slip R2 is a document on which the fact of the purchase of the tax exemption article is recorded. Two purchase record slips R2 shown in FIG. 18 are printed for the use of the addition to the document (purchase record slip) and the use of the copy reserved at the store. The purchase record slip R2 for addition is adhered to the document (purchase record slip). The document (purchase record slip) is adhered to the passport and is subjected to the tally impression.

As shown in FIG. 18, the purchase record slip R2 includes the full name or name a of the businessman who runs the duty-free store, the competent tax office name b, the store address of the duty-free store c, the transaction date d, the transaction number e, the register number f, the details of the commodity (commodity name g, quantity and price h of each commodity name), the total amount i of all the articles, the total amount j of the general goods, the total amount j of the consumables and the tax exemption amount k.

The purchase record slip R2 includes a column at which the character string of each item confirmed on the confirmation screen G3 is printed. Specifically, character strings of the following items confirmed on the confirmation screen G3 are printed in the purchase record slip R2.
passport number . . . l
nationality of the purchaser . . . m
full name of the purchaser . . . n
birth date of the purchaser . . . o

Further, similar to the purchase written oath R1, only the name of the item (character string) deleted through the operation of the deletion button B1 on the confirmation screen G3 is printed and the item is directly written on the document (purchase record slip). The layout of the purchase record slip R2 is not limited to the example in FIG. 18.

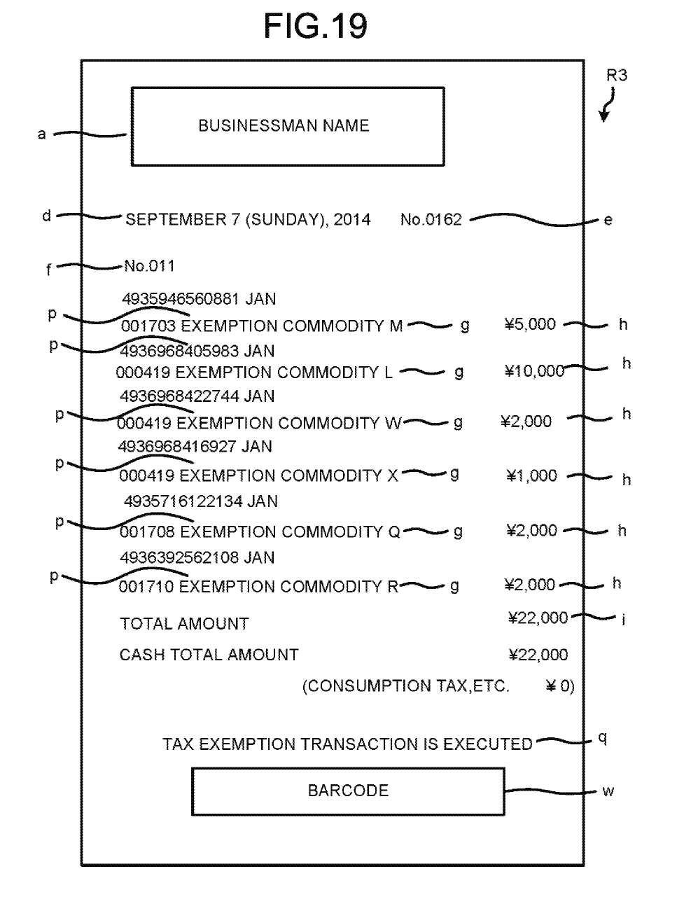

Next, the receipt is described. FIG. 19 is a diagram illustrating an example of a receipt R3. The receipt R3 is delivered to the purchaser after the transaction.

As shown in FIG. 19, the receipt R3 includes the full name or name a of the businessman who runs the duty-free store, the transaction date d, the transaction number e, the register number f, the details of the commodity (commodity name g, quantity and price h of each commodity name) and the total amount i of all the articles. As shown in FIG. 19, in the case of the tax exemption object completion commodity, an “exemption” p is printed as a tax printing. In the case of the tax exemption transaction, a tax exemption message “tax exemption transaction is carried out.” q is printed on the receipt R3. A barcode w obtained by coding the transaction number e is printed on the receipt R3.

In a case in which the information stored in the transaction history database DB1 does not function as a journal, the control section 300 executes a journal printing corresponding to the purchase record slip R2 and the receipt R3. At this time, the control section 300 prints character strings of all or part of the items confirmed on the confirmation screen G3 on the journal corresponding to the receipt R3.

In this way, the control section 300 reads the specific character string from the passport with the use of the passport reader 27 and displays the read character string on the confirmation screen G3 for the operator to confirm the read character string. The control section 300 prints the character string displayed on the confirmation screen G3 after confirmed by the operator on the document such as the purchase written oath. In this way, according to the POS terminal 2 of the embodiment, as troublesome procedures such as the filling in the purchaser written oath or purchase record slip every time the commodity is purchased are unnecessary, procedures relating to the tax exemption can be efficiently executed.

In a case in which the commodity amount is greater than the tax exemption reference amount (consumables: 5,000 Yen, general goods: 10,000 Yen) in the tax exemption division unit (consumables, general goods), the control section 300 automatically executes the tax exemption processing. In this way, according to the POS terminal 2 of the embodiment, the tax exemption registration operation through the determination of the operator is unnecessary, and the sales registration processing of the commodity corresponding to correction of the tax exemption system can be executed.

If receiving the operation of the commodity name list output key K2, the control section 300 executes a printing processing for outputting the commodity name list (not shown) of the commodities serving as the tax exemption objects. Herein, the timing at which the operation of the commodity name list output key K2 is received is not specifically limited. For example, if the operation of the commodity name list output key K2 is received in the process of executing the sales registration processing, the control section 300 executes a list printing processing together with the printing processing described above. If the operation of the commodity name list output key K2 is received at the time the sales registration processing is not executed, the control section 300 executes the list printing processing after the transaction number of the transaction serving as the object of the list printing processing is input.

In the list printing processing of the embodiment, one commodity name list is printed. The commodity name list is a document used to exemplify the commodities serving as the objects of the tax exemption processing. The commodity name list is added to a bag or a box for packaging the commodity serving as the object of the tax exemption processing.

The commodity name list includes the full name or name of the businessman who runs the duty-free store, the commodity name of the commodity serving as the object of the tax exemption processing, and the quantity and the price of each commodity name. It may be applicable that only consumables among the commodities serving as the objects of the tax exemption processing are printed on the commodity name list. In this case, the determination about whether or not the commodity is the consumables is executed based on the tax exemption division code in the commodity master file F1 or the tax exemption division file F2. In a case in which the POS terminal 2 is separately arranged with a label printer, it may be applicable that the control section 300 prints the commodity name list with the use of the label printer.

In this way, according to the POS terminal 2, in response to the operation of the commodity name list output key K2, the commodity name list of the commodities serving as the objects of the tax exemption processing can be output. In this way, according to the POS terminal 2 of the embodiment, in a case in which the display of the commodity name on the package of the commodity serving as the tax exemption object is regulated by the decree, as the commodity name list can be easily issued, the procedures relating to the tax exemption can be efficiently executed.

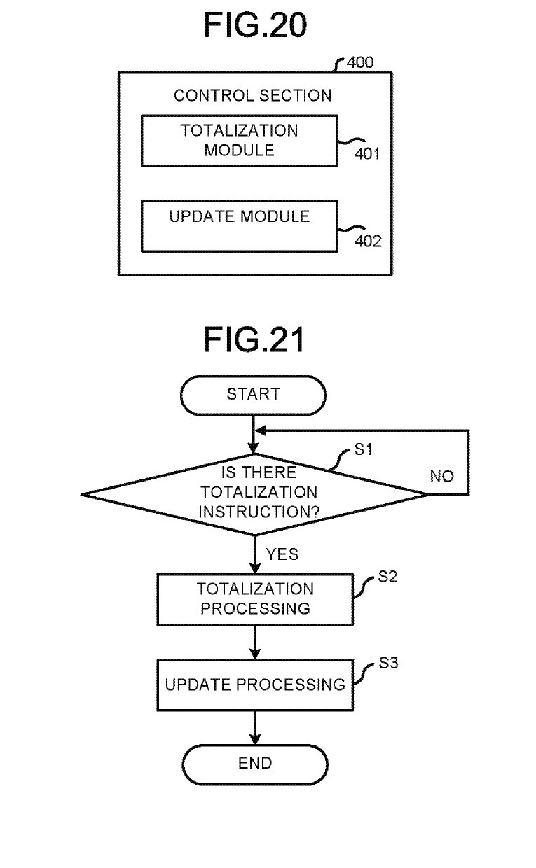

Sequentially, with reference to FIG. 20 and FIG. 21, the control processing executed according to the control program 481 by the control section 400 of the server 4 according to the embodiment is described.

FIG. 20 is a functional block diagram illustrating the functional components of the control section 400 of the server 4. The control section 400 functions as a totalization module 401 and an update module 402 according to the control program 481 stored in the HDD 48.

The totalization module 401 totals the transaction history for each country or region of people who receive the tax exemption processing in association with the commodity code of the commodity serving as the object of the tax exemption processing on the basis of the transaction information stored in the transaction history database DB1 in a predetermined period (for example, by day) at a predetermined timing.

The update module 402 updates totalization information in the tax exemption sales daily achievement database DB2 on the basis of a totalization result obtained by the totalization module 401.

FIG. 21 is a flowchart illustrating the flow of a control processing of the server 4. As shown in FIG. 21, the control section 400 (totalization module 401) of the server 4 determines whether or not there is a totalization instruction according to the operation of the operator or the predetermined timing (Act S1). If it is determined that there is the totalization instruction (Yes in Act S1), the control section 400 (totalization module 401) totals the transaction history in the predetermined period (for example, by day) for each country or region of people who receive the tax exemption processing in association with the commodity code of the commodity serving as the object of the tax exemption processing on the basis of the information stored in the transaction history database DB1 (Act S2).

Specifically, the totalization processing totals sales information (sales amount, the number of sales, the number of customers and the like) of each commodity serving as the object of the tax exemption processing in the predetermined period (for example, daily) and further adds information of the country or the region of the people who receive the tax exemption processing.

Next, the control section 400 (update module 402) of the server 4 executes an update processing for updating the totalization information in the tax exemption sales daily achievement database DB2 on the basis of the totalization result in Act S2 (Act S3).

In this way, according to the server 4 of the present embodiment, by totaling the sales information (the sales amount, the number of sales, the number of customers and the like) of each commodity serving as the object of the tax exemption processing during the predetermined period (for example, by day), it is possible to analyze the sales information of the tax exemption commodity of each single article. Further, by adding the information of the country or the region of the people who receive the tax exemption processing, it is possible to publish a POP advertising (Point Of Purchase advertising) in the language for the country or the region for a salable commodity at each country or region to assist in sales.

In the present embodiment, the operator of the POS terminal 2 reads the character string of the nationality recorded in the passport with the passport reader 27 to input the character string; however, the present invention is not limited to this. For example, the operator of the POS terminal 2 may input the character string of the nationality recorded in the passport via the keyboard 21.

Further, in the present embodiment, the transaction information (the transaction number, the transaction date and time, the register number, the commodity code, the unit price, the number of sales and the like) of the commodity to which the settlement processing is carried out, the tax exemption information and the country or the region of people who receive the tax exemption processing are stored in the transaction history database DB1; however, the present invention is not limited to this. For example, data of the commodity relating to the tax exemption processing based on the purchase written oath R1 or the purchase record slip R2 issued in the tax exemption processing by the POS terminal 2 may be stored in the transaction history database DB1.

While certain embodiments are described, these embodiments are presented byway of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An information processing apparatus, comprising:
a transaction history database configured to store transaction information which comprises transaction history at least containing a commodity code, unit price, and a number of sales of a commodity transacted through a commodity sales data processing apparatus that carries out a sales registration processing relating to a transaction of the commodity and a transaction number for identifying the transaction, tax exemption information indicating that a tax exemption processing is carried out for the transaction through the commodity sales data processing apparatus in association with the transaction number and countries or regions of people who receive the tax exemption processing input at a time of the tax exemption processing;
a tax exemption sales achievement database configured to store totalization information obtained by totaling the transaction history for each country or region of the people who receive the tax exemption processing in association with the commodity code of the commodity serving as an object of the tax exemption processing in a predetermined period;
a totalization module configured to total the transaction history for each country or region of the people who receive the tax exemption processing in association with the commodity code of the commodity serving as the object of the tax exemption processing on the basis of the transaction information stored in the transaction history database in the predetermined period at a predetermined timing; and
an update module configured to update the totalization information in the tax exemption sales achievement database on the basis of a totalization result obtained by the totalization module.

2. The information processing apparatus according to claim 1, wherein
the country or the region of people who receive the tax exemption processing stored in the transaction history database is input by reading a character string of nationality recorded in a passport with a reading device.

3. The information processing apparatus according to claim 1, wherein
the country or the region of people who receive the tax exemption processing stored in the transaction history database is obtained by inputting the character string of the nationality recorded in the passport via a keyboard.

4. The information processing apparatus according to claim 1, wherein
the transaction information stored in the transaction history database is data based on a purchase written oath or a purchase record slip issued in the tax exemption processing through the commodity sales data processing apparatus.

5. The information processing apparatus according to claim 1, wherein
a totalization period of the totalization module is by day, by week or by month.

6. An information processing method, comprising:
storing transaction information which comprises transaction history at least containing a commodity code, unit price, and a number of sales of a commodity transacted through a commodity sales data processing apparatus that carries out a sales registration processing relating to a transaction of the commodity and a transaction number for identifying the transaction, tax exemption information indicating that a tax exemption processing is carried out for the transaction through the commodity sales data processing apparatus in association with the transaction number and countries or regions of people who receive the tax exemption processing input at a time of the tax exemption processing;
storing totalization information obtained by totaling the transaction history for each country or region of the people who receive the tax exemption processing in association with the commodity code of the commodity serving as an object of the tax exemption processing in a predetermined period;
totaling the transaction history for each country or region of the people who receive the tax exemption processing in association with the commodity code of the commodity serving as the object of the tax exemption processing on the basis of the transaction information stored in a transaction history database in the predetermined period at a predetermined timing; and
updating the totalization information in a tax exemption sales achievement database on the basis of a totalization result.

7. The information processing method according to claim 6, wherein
the country or the region of people who receive the tax exemption processing stored in the transaction history database is input by reading a character string of nationality recorded in a passport.

8. The information processing method according to claim 6, wherein
the country or the region of people who receive the tax exemption processing stored in the transaction history database is obtained by inputting the character string of the nationality recorded in the passport.

9. The information processing method according to claim 6, wherein
the transaction information stored in the transaction history database is data based on a purchase written oath or a purchase record slip issued in the tax exemption processing.

10. The information processing method according to claim 6, wherein
a totalization period of the totaling is by day, by week or by month.
